(19) United States
(12) Patent Application Publication
(10) Pub. No.: US 2010/0329081 A1
(43) Pub. Date: Dec. 30, 2010

(54) METHOD FOR NON-DESTRUCTIVELY EVALUATING ROTARY EARTH BORING DRILL COMPONENTS AND DETERMINING FITNESS-FOR-USE OF THE SAME

(76) Inventors: Eric Sullivan, Houston, TX (US); David Curry, The Woodlands, TX (US); Xiamin Cheng, The Woodlands, TX (US); Tu Tien Trinh, Houston, TX (US); Terry Watts, Spring, TX (US); John F. Bradford, Katy, TX (US); Aaron J. Dick, Houston, TX (US); Chih Lin, Spring, TX (US)

Correspondence Address: CANTOR COLBURN LLP, 20 Church Street, 22nd Floor, Hartford, CT, 06103, US

(21) Appl. No.: 12/492,705

(22) Filed: Jun. 26, 2009

(51) Int. Cl. G01S 3/80; E21B 10/36

(52) U.S. Cl. 367/120; 175/432

(57) ABSTRACT

A method of non-destructively identifying and characterizing defects in a rotary drill component is provided. The method includes providing a drill component and an ultrasonic test system including a phased array ultrasonic transducer (PAUT). The method also includes acoustically coupling the PAUT to a surface location, transmitting focused ultrasonic acoustic waves at the location into the PAUT and recording a reflected acoustic response corresponding to a portion of a predetermined volume of a microstructure of the component associated with the location on the surface. The method also includes storing the response and moving one of the transducer or the component to a plurality of unique locations representative of the predetermined microstructure and repeating these steps. The method also includes processing the responses and providing an output signal to an output device configured to provide an output indicative of differences in the output signal within the predetermined volume of the microstructure.

### BACKGROUND

Various rotary drill components are used for drilling boreholes or wells in earth formations. Examples include various rotary roller-cone drill bits, rotary fixed-cutter or drag drill bits, rotary bit bearings and or drilling subs. Rotary roller-cone bits generally include three roller cones mounted on support legs extending from a bit body. Rotary fixed-cutter bits generally include an array of cutting elements secured to a face region of the bit body. A hard, superabrasive material, such as mutually bonded particles of polycrystalline diamond, may be provided on a surface of each cutting element to provide a cutting surface. Such cutting elements are often referred to as “polycrystalline diamond compact” (PDC) cutters. Typically, the cutting elements are fabricated separately from the bit body and secured within pockets formed in the outer surface of the bit body. A bonding material, such as an adhesive or a braze alloy, may be used to secure the cutting elements to the bit body. A fixed-cutter drill bit is placed in a borehole such that the cutting elements are in contact with the earth formation to be drilled. As the drill bit is rotated, the cutting elements scrape across and shear away the surface of the underlying formation. Rotary drill components, particularly the drills themselves, frequently are assembled or manufactured using joints, such as various weldments and other metallurgical bonds that require wetting of a molten metal with one or more solid or semi-solid interface surfaces.

For example, fixed-cutter drill bits may include a bit body formed from a particle-matrix composite material. Such materials include hard particles randomly dispersed throughout a matrix material (often referred to as a “binder” material.) Particle-matrix composite material bit bodies may be formed by embedding a metal blank in a carbide particulate material volume, such as particles of tungsten carbide, and then infiltrating the particulate carbide material with a matrix material, such as a copper alloy. A joint, including a metallurgical bond formed between the blank and bit body, particularly the matrix material, fixes the blank to the particle-matrix composite material.

Drill bits that have a bit body formed from such particle-matrix composite materials offer significant advantages over all-steel bit bodies, including increased erosion and wear resistance, but generally have relatively lower strength and toughness that limit their use in certain applications. This lower strength and toughness can be related to defects and discontinuities, particularly cracks, in the microstructure that result from the manufacturing process. For example, U.S. Pat. No. 5,101,692 indicates that a breakdown may occur between a steel core and a tungsten carbide matrix shell, and further that differential contraction between the shell and core may cause cracking particularly in the larger products. Cracks may also initiate and propagate in service, during use of the bit in the borehole under cyclic rotational loading, and also including axial loading during periodic withdrawal of the drill string and bit. They may also develop during remanufacture or rework of the drill bit such as, for example, where a bit is damaged during service, or where as-manufactured defects are observed and corrected prior to placing the bit into service. While a particular example is provided with regard to particle-matrix composite drill bits, virtually all rotary drill components that employ metallurgical bonds can have an increased likelihood of failure related to defects and discontinuities, particularly cracks, associated with these bonds. Cracking related failures are particularly problematic in that down-hole failure of a drill string is very costly.

Various methods are known for non-destructively identifying discontinuities in rotary drill components. For example, U.S. Pat. No. 7,149,339 describes the use of non-destructive X-ray computed tomography to identify voids in down-hole equipment, such as packers.

While various methods are known for identifying discontinuities, there remains a need for effective non-destructive evaluation methods that may be employed with various earth-boring rotary drill components to effectively identify discontinuities and defects, such as cracks, and use this information to improve drill bit reliability and utilization.

### SUMMARY

In an exemplary embodiment, a method of identifying and characterizing defects in a rotary drill component is disclosed. The method includes providing a rotary drill component. The method also includes providing an ultrasonic test system comprising a phased array ultrasonic transducer, an ultrasonic signal generator, a signal processor and a storage device. Further, the method includes acoustically coupling the phased array ultrasonic transducer to a location on a surface of the component. Still further, the method includes transmitting a plurality of focused ultrasonic acoustic waves into the surface at the location using the phased array ultrasonic transducer and recording a reflected acoustic wave response to the transmitted acoustic waves corresponding to a portion of a predetermined volume of a microstructure of the component associated with the location on the surface. Still further, the method includes storing the acoustic wave response of the volume of microstructure associated with location using the storage device. Yet further, the method includes moving one of the transducer or the component relative to the other to a plurality of unique locations on the surface, each of the plurality of locations corresponding to a respective portion of the predetermined volume of the microstructure, repeating the steps of transmitting and recording for the acoustic wave response associated with each of the plurality of locations, wherein the sum of the respective portions equals the predetermined volume. Still further, the method includes processing the acoustic wave responses associated with the predetermined volume of microstructure and providing an output signal representative of the reflected acoustic wave responses to an output device, wherein the output device is configured to provide an output indicative of differences in the output signal within the predetermined volume of the microstructure.

In another exemplary embodiment, a method of determining fitness-for-use of a rotary drill component is disclosed. The method includes providing a rotary drill bit component having a predetermined volume of a microstructure. The method also includes determining the fracture toughness of the predetermined volume of the microstructure. Further, the method includes using numerical analysis to parametrically evaluate an effect on a stress intensity factor of a crack within the predetermined volume of the microstructure based on the load, crack length, crack width and crack location for a range of possible values of load, crack length, crack width and crack location. Still further, the method includes using a non-destructive evaluation method to analyze the predetermined volume of the microstructure of the rotary drill component to determine whether a crack exists within the predetermined volume, and if no crack exists, determining that the component is fit for use up to a predetermined maximum design load, and if a crack exists, determining the actual crack length, actual crack width and actual crack location. Yet further, the method includes using an assumed load, the fracture toughness and the stress intensity factor associated with the actual crack length, actual crack width and actual crack location to determine fitness-for-use of the rotary drill component.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, wherein like reference numerals are used for like elements in the several views:

FIG. 1 is a flow chart illustrating an exemplary embodiment of a method of non-destructively evaluating rotary earth-boring drill components as disclosed herein;

FIG. 2 is a partial cross-sectional view of an exemplary embodiment of an earth-boring rotary drill bit as disclosed herein;

FIG. 3 is an optical photomicrograph of a discontinuity in the chamfer area of an earth-boring rotary drill bit as disclosed herein;

FIG. 4 is a partial cross-sectional view of a phased array ultrasonic test system for an earth-boring rotary drill bit as disclosed herein;

FIG. 5 is a perspective view of an exemplary embodiment of a calibration bit as disclosed herein;

FIG. 6 is a top plan view of the calibration bit of FIG. 5;

FIG. 7 is a collection of NDE images of an exemplary drill bit component according to the method of FIG. 1;

FIG. 8 is a collection of NDE images of a second exemplary drill bit component according to the method of FIG. 1;

FIG. 9 is a c-scan NDE image of a third exemplary drill bit component according to the method of FIG. 1;

FIG. 10 is a flow chart illustrating an exemplary embodiment of a method of determining fitness-for-use of a rotary drill bit as disclosed herein;

FIG. 11 is a table illustrating exemplary qualitative defect observation, strain rate and tensile failure load data for several particle-matrix drill bits as disclosed herein;

FIG. 12 is a schematic partial-cross-sectional illustration of a tensile test fixture for a particle-matrix drill bit as disclosed herein;

FIG. 13 is an enlarged schematic cross-sectional illustration an exemplary particle matrix drill bit as disclosed herein;

FIG. 14 is a schematic cross-sectional illustration of a “½T” CT specimen taken from region 2 of FIG. 13;

FIG. 15A is plot of fracture toughness (K) from comparative empirical and numerical CT evaluations;

FIG. 15B is a table of fracture toughness related information associated with FIG. 15A;

FIG. 16 is a perspective, cross-sectional illustration of a finite element web used in the parametric evaluation of stress intensity factors for a particle-matrix drill bit as disclosed herein;

FIG. 17 is an enlarged perspective, cross-sectional illustration of the finite element web of FIG. 16;

FIGS. 18A-18-D are plots of crack related information associated with from the parametric evaluation of stress intensity factors for a particle-matrix drill bit as disclosed herein;

FIG. 19 is a plot of stress intensity as a function of crack separation angle developed from the parametric evaluation of stress intensity factors for a particle-matrix drill bit as disclosed herein;

FIGS. 20-23B are plots of stress intensity as a function of crack front position developed from the parametric evaluation of stress intensity factors for a particle-matrix drill bit as disclosed herein;

FIGS. 24-27 are Failure Analysis Diagrams for exemplary particle-matrix drill bits as disclosed herein;

FIG. 28 are c-scan NDE images according to the method of FIG. 1 of three exemplary drill bit components as disclosed herein;

FIGS. 29 and 30 are Failure Analysis Diagrams for exemplary particle-matrix drill bits as disclosed herein; and

FIG. 31 is c-scan NDE image according to the method of FIG. 1 of an exemplary drill bit component as disclosed herein overlaid with several fitness-for-use criteria as disclosed herein.

### DETAILED DESCRIPTION

Except for photographs, the illustrations presented herein, are not meant to be actual views of any particular material, apparatus, system, or method, but are merely idealized representations of that which is disclosed herein. Additionally, elements common between figures may retain the same numerical designation.

As used herein, the term “[metal]-based alloy” (where [metal] is any metal) means commercially pure [metal] in addition to [metal] alloys wherein the weight percentage of [metal] in the alloy is greater than the weight percentage of any other component of the alloy. Where two or more metals are listed in this manner, the weight percentage of the listed metals in combination is greater than the weight percentage of any other component of the alloy.

As used herein, the term “material composition” means the chemical composition and microstructure of a material. In other words, materials having the same chemical composition but a different microstructure are considered to have different material compositions.

As used herein, the term “tungsten carbide” means any material composition that contains chemical compounds of tungsten and carbon in any stoichiometric or non-stoichiometric ratio or proportion, such as, for example, WC, W₂C, and combinations of WC and W₂C. Tungsten carbide includes any morphological form of this material, for example, cast tungsten carbide, sintered tungsten carbide, and macrocrystalline tungsten carbide.

Particle-matrix composite bit bodies are used in earth-boring drill bits under very extreme conditions, including extremes of cyclical loading due to axial and rotation movement of the drill string. Under these extreme use conditions, both partial and complete separation of the bit bodies has been observed due to cracking in certain highly stressed regions. One region of the bit bodies where cracking has been observed is the area surrounding the blank, particularly the metallurgical bond between the particle-matrix bit body and steel blank that attaches the bit body on one end and a drill shank on the other end. In particular, cracking has been observed to occur in the chamfer region of the blank which provides the interface and metallurgical bond between the blank and bit body. The cracks generally are hidden within the bit body in the joint or metallurgical bond between the crown and blank. Examination of the microstructure of these joints has indicated that grain boundary intermetallic compounds and separation may be associated with these defects. Failure of the cracks has been encountered during, for example, during tensile “over pulls”, where the tensile load exceeds a design maximum. Discontinuities in the body-blank joint, depending upon the size, location and frequency, can diminish the reliability of the bit in service. These cracks sometimes exist in as-manufactured particle-matrix drill bits. They have also been observed to initiate and propagate down-hole while the drill bits are in service. They have further been observed to exist following remanufacture of the drill bits after failure in service, or following rework of drill bits in conjunction with the manufacturing process, e.g., when a bit body does not meet manufacturing acceptance criteria. Such cracking may occur where the metallurgical bond between the bit body and blank is affected, e.g., during solidification of the metallurgical bond along this interface during manufacturing, or resolidification during remanufacturing or rework. Cracks may also initiate and propagate in service under load at various discontinuities in the metallurgical bond between them. Given possible existence of cracks throughout the life cycle of particle-matrix composite bit bodies, there is a need to non-destructively assess the metallurgical bonds used to attach them to determine whether a crack, or plurality of cracks, exist, and if a crack exists, to also assess its potential impact on the desired use of the bit in a given application, or stated differently, the fitness-for-use of the bit in a given application or range of applications.

Applicant's have discovered a non-destructive evaluation (NDE) method using phased array ultrasound that may be used to identify, image and measure PDC bit chamfer-area discontinuities, as well as a method of determining PDC bit chamfer-area fitness-for-service using fracture mechanics concepts, characteristics of the discontinuities that may be measured using the aforementioned method, and anticipated service loads. These methods are also applicable to other rotary drill components that also have metallurgical bonds or other features. For a given particle-matrix-composite PDC bit and for an assumed load, chamfer-area fitness-for-service can be inferred from: (1) discontinuity characterizations derived using non-destructive evaluation (NDE) techniques, (2) empirically-determined or numerically determined interface fracture toughness and (3) stress intensity factors developed using numerical methods.

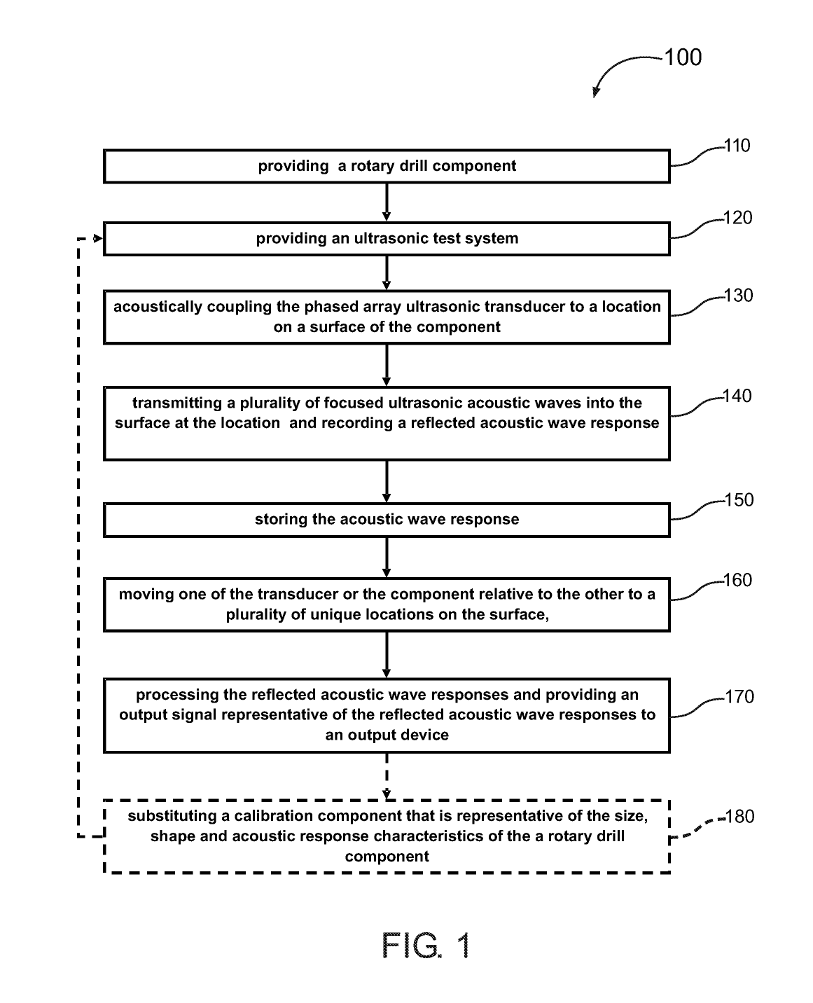

Referring to FIG. 1, a method 100 of identifying and characterizing defects and discontinuities, particularly cracks, in a rotary drill component is provided. The method includes providing 110 a rotary drill component. This may broadly include any rotary drill component, which may be interpreted as any item used in downhole operations, including drilling, extraction, service and the like, including various tools and components, or portion thereof. More particularly, this includes a rotary roller-cone earth boring drill bits, rotary fixed-cutter earth boring drill bits, rotary diamond-impregnated earth boring drill bits, rotary natural diamond earth boring bits, rotary coring bits, rotary bit bearings for rotary earth boring drill bit, or drilling subs. This also includes various welds, bonds, joints, chamfers and other features or aspects of rotary drill components. While method 100 may be used with any rotary drill component where cracking is possible, it is particularly suitable for components that include a joint having a metallurgical bond between elements of the component. It is particularly suitable for use with particle-matrix composite drill bits.

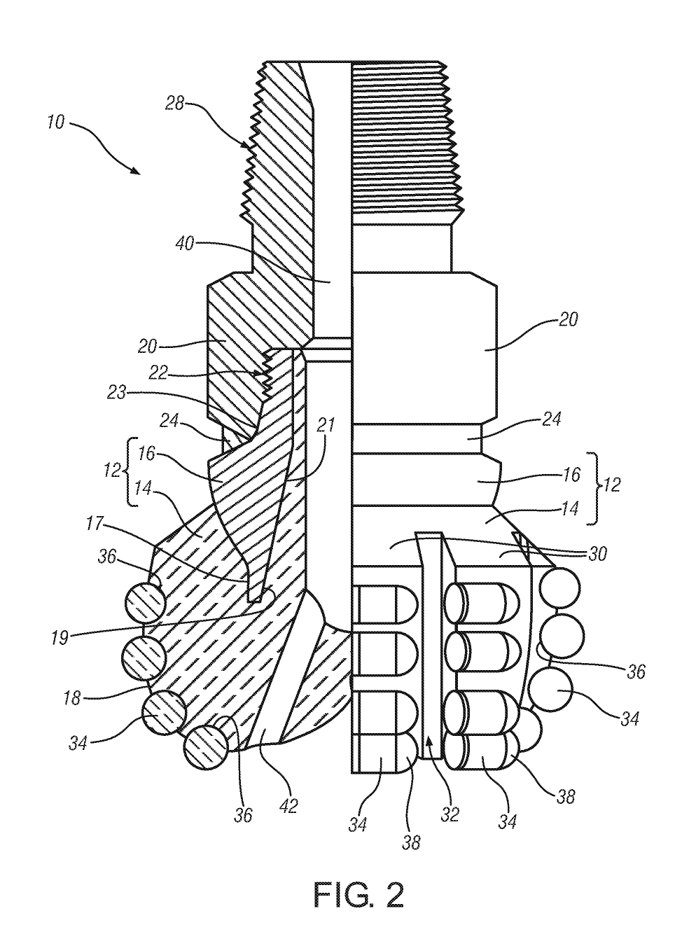

An exemplary embodiment of an earth-boring rotary drill bit 10 having a bit body 12 that includes a particle-matrix composite material is illustrated in FIG. 2. The bit body 12 is secured to a shank 20, such as a steel shank. The bit body 12 includes a crown 14, and a metal blank 16 that is partially embedded in the crown 14. The crown 14 includes the particle-matrix composite material. Many other configurations of rotary drill bit 10 are possible including configurations in which the bit body 12 is not secured to a metal blank, such as metal blank 16, but rather is secured directly to a shank (not shown), where the shank performs the role of the takes the place of the blank.

The particle-matrix composite material may include any suitable particle-matrix composite material that has the desired characteristics and material properties for the desired drilling application. In an exemplary embodiment, the matrix material may include a pure metal or metal alloy. In another exemplary embodiment, the matrix material may include a Cu alloy, and more particularly a Cu—Mn—Zn alloy. Suitable Cu alloys, including Cu—Mn—Zn alloys, are described in U.S. Pat. No. 5,000,273, which is hereby incorporated by reference herein in its entirety. This patent describes a binder (matrix) comprising about 5-65% by weight of manganese, up to about 35% by weight of zinc, and the balance copper. More particularly, it describes a binder comprising 20-30% by weight of manganese, about 10-25% zinc, and the balance copper. Even more particularly, it describes a binder comprising about 20% by weight of manganese, about 20% by weight of zinc and the balance copper, as well as a binder composition comprising about 20% by weight of manganese, about 25% by weight of zinc, and the balance copper. The binder alloys described in this patent may also comprise up to about 5% of an additional alloying element, where the alloying element is selected from the group consisting of silicon, tin and boron, and combinations thereof. Another exemplary Cu—Mn—Zn alloy also comprises Ni as an alloying constituent, more particularly Ni in an amount up to about 16% by weight. Many metals and metal alloys, including the various Cu alloy material compositions described herein, may be used as the matrix material for crown 14, and any suitable combination of particles and matrix materials may be used to make the particle-matrix composite material of crown 14. The particle-matrix material of the crown 14 may include a plurality of hard particles dispersed randomly throughout the matrix material. The hard particles may comprise diamond or ceramic materials such as various carbides, nitrides, oxides, and borides (including boron carbide (B₄C)) and combinations of them, such as carbonitrides. More specifically, the hard particles may comprise carbides and borides made from elements such as W, Ti, Mo, Nb, V, Hf, Ta, Cr, Zr, Al, or Si. By way of example and not limitation, materials that may be used to form hard particles include tungsten carbide (WC, W₂C), titanium carbide (TiC), tantalum carbide (TaC), titanium diboride (TiB₂), chromium carbides, titanium nitride (TiN), vanadium carbide (VC), aluminum oxide (Al₂O₃), aluminum nitride (AlN), boron nitride (BN), and silicon carbide (SiC). In an exemplary embodiment, when using Cu alloy materials as the matrix, it is particularly desirable to use tungsten carbide particles in the various morphologies described herein to form the particle-matrix composite material. Furthermore, combinations of different hard particles may be used to tailor the physical properties and characteristics of the particle-matrix material. The hard particles may be formed using techniques known to those of ordinary skill in the art. Most suitable materials for hard particles are commercially available and the formation of the remainder is within the ability of one of ordinary skill in the art.

As described herein, a bit body 12 is configured to carry one or more cutters 34 for engaging a subterranean earth formation. The bit body 12 includes a particle-matrix composite material as described herein having a plurality of hard particles dispersed throughout a matrix material.

As also illustrated in FIG. 2, the bit body 12 is secured to the steel shank 20 by way of a threaded connection 22 and a weld 24 extending around the drill bit 10 on an exterior surface thereof along an interface between the bit body 12 and the steel shank 20. The steel shank 20 includes an API threaded connection portion 28 for attaching the drill bit 10 to a drill string (not shown).

The bit body 12 includes wings or blades 30, which are separated by external channels or conduits also known as junk slots 32. Internal fluid passageways 42 or nozzle ports extend between the face 18 of the bit body 12 and a longitudinal bore 40, which extends through the steel shank 20 and partially through the bit body 12. Nozzle inserts (not shown) may be provided at face 18 of the bit body 12 within the internal fluid passageways 42.

A plurality of polycrystalline diamond compact (PDC) cutters 34 may be provided on the face 18 of the bit body 12. The PDC cutters 34 may be bonded to the face 18 of the bit body 12 after the bit body 12 has been cast by, for example, brazing, mechanical, or adhesive affixation. Alternatively, the cutters 34 may be bonded to the face 18 of the bit body 12 during forming of the bit body 12 if thermally stable synthetic or natural diamonds are employed in the cutters 34. The PDC cutters 34 may be provided along the blades 30 within pockets 36 formed in the face 18 of the bit body 12, and may be supported from behind by buttresses 38, which may be integrally formed with the crown 14 of the bit body 12.

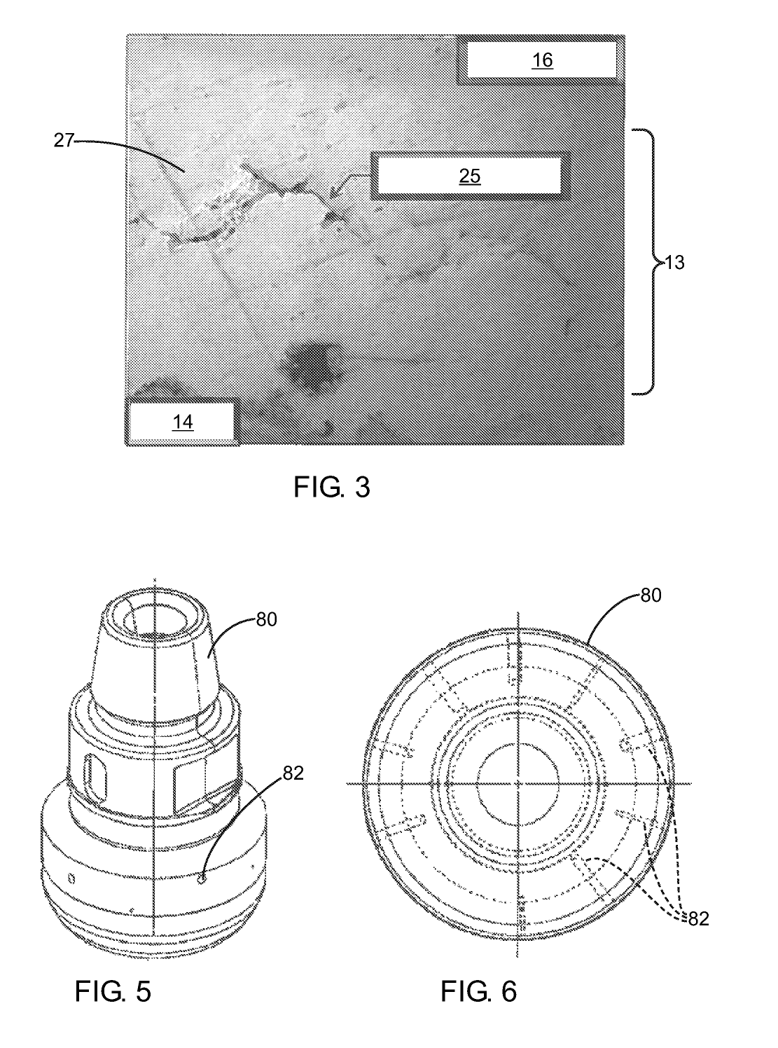

The metal blank 16 shown in FIG. 2 is generally cylindrically tubular. Metal blank 16 may include a chamfer 17 that tapers inwardly to a tang 19 on the lowermost portion of metal blank 16. Chamfer 17 and tang 19 are embedded in crown 14. During the process of infiltrating the particles of crown 14 with a matrix material, as described herein, a joint 27 is formed that includes a metallurgical bond 13 between metal blank 16 and crown 14, and more particularly between the matrix material of crown 14 and metal blank 16, as shown in FIG. 3. Alternatively, the metal blank 16 may have a fairly complex configuration and may include external protrusions corresponding to blades 30 or other features on and extending on the face 18 of the bit body 12 (not shown), or a plurality of annularly or radially spaced slots or other features that extend through the annular wall of blank 16 which facilitate continuity of the particle-matrix composite material between an inner surface 21 and outer surface 23 of metal blank 16. By way of example and not limitation, metal blank 16 may comprise a ferrous alloy, such as steel. It is in the area proximate chamfer 17 and tang 19 that discontinuities or defects, such as cracks, have been observed in the microstructure of the particle-matrix composite of crown 14, particularly that portion of the microstructure associated with and proximate to the metallurgical bond 13 between the matrix material and metal blank 16. The area or region may be described as a volume of the microstructure of the crown/blank where cracks may occur, and is described elsewhere herein as a predetermined volume of this microstructure. An example of a discontinuity in the form of crack 25 is also shown in FIG. 3. Discontinuities and defects, including cracks, have been observed in bit body 12 and crown 14 in the as-manufactured condition (prior to placing drill bit 10 into service). They have also been observed in drill bits 10 post-service after the bits have been removed from a bore hole. Discontinuities have also been observed in drill bits 10 in a post-repair or post-rework condition, that is a drill bit that has been restored, either as part of a rework process for as-manufactured drill bits that do not meet one or more acceptance criteria, or after repairing a post-service drill bit that requires repair proximate the chamfer or tang.

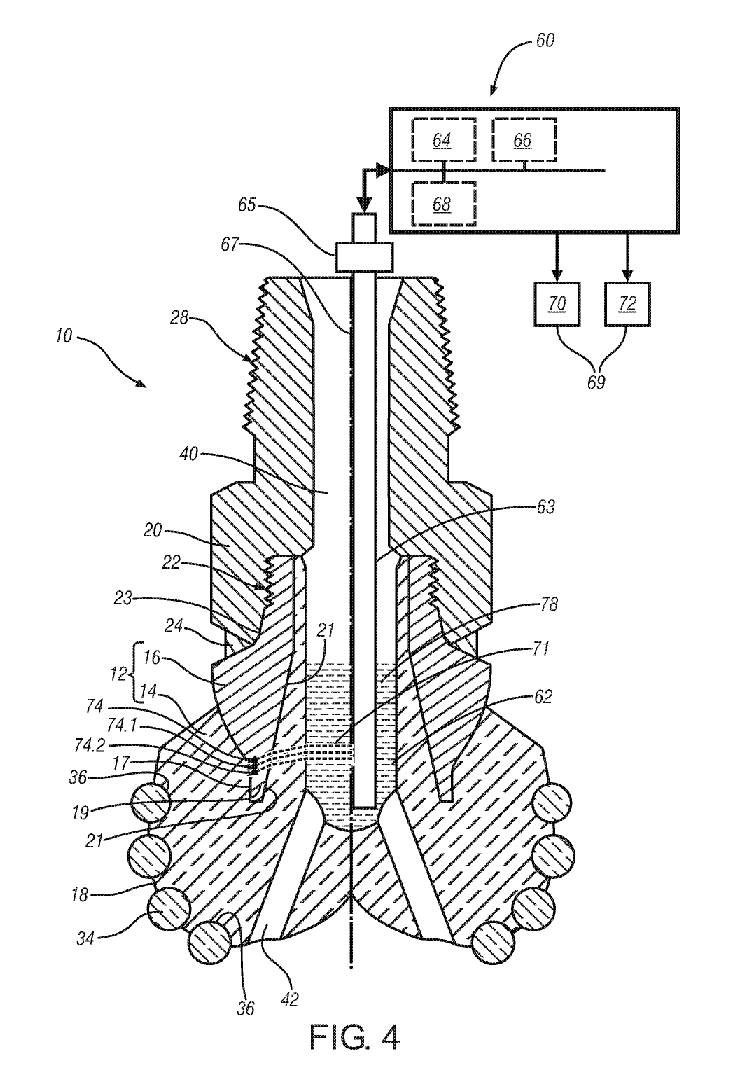

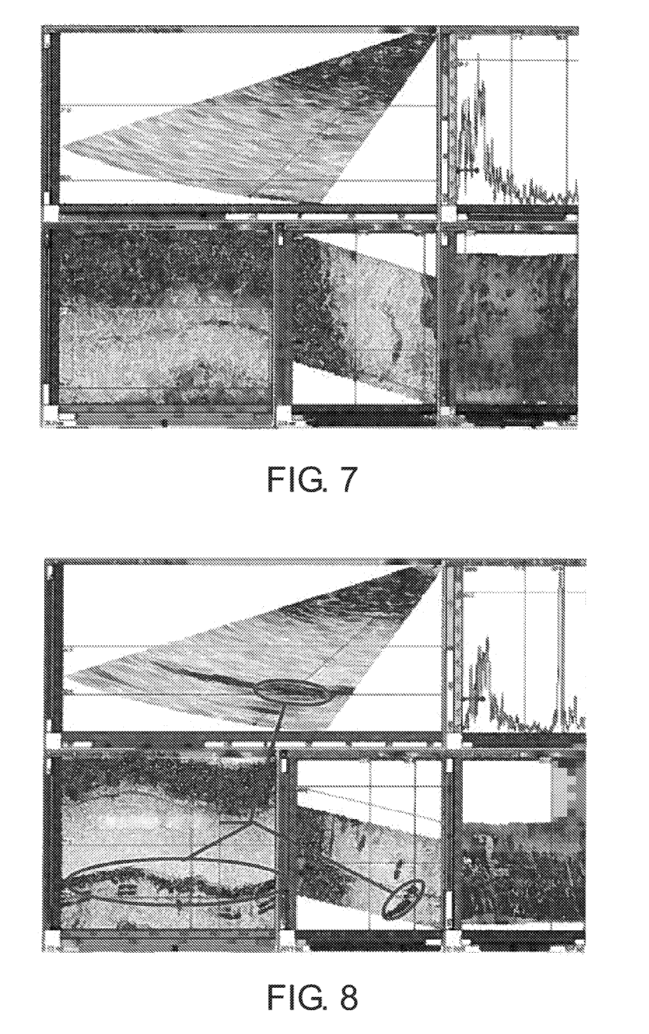

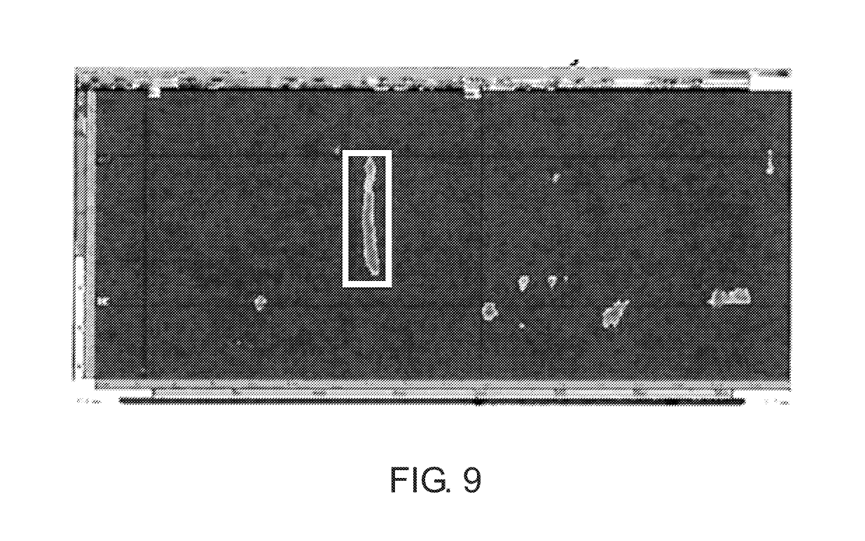

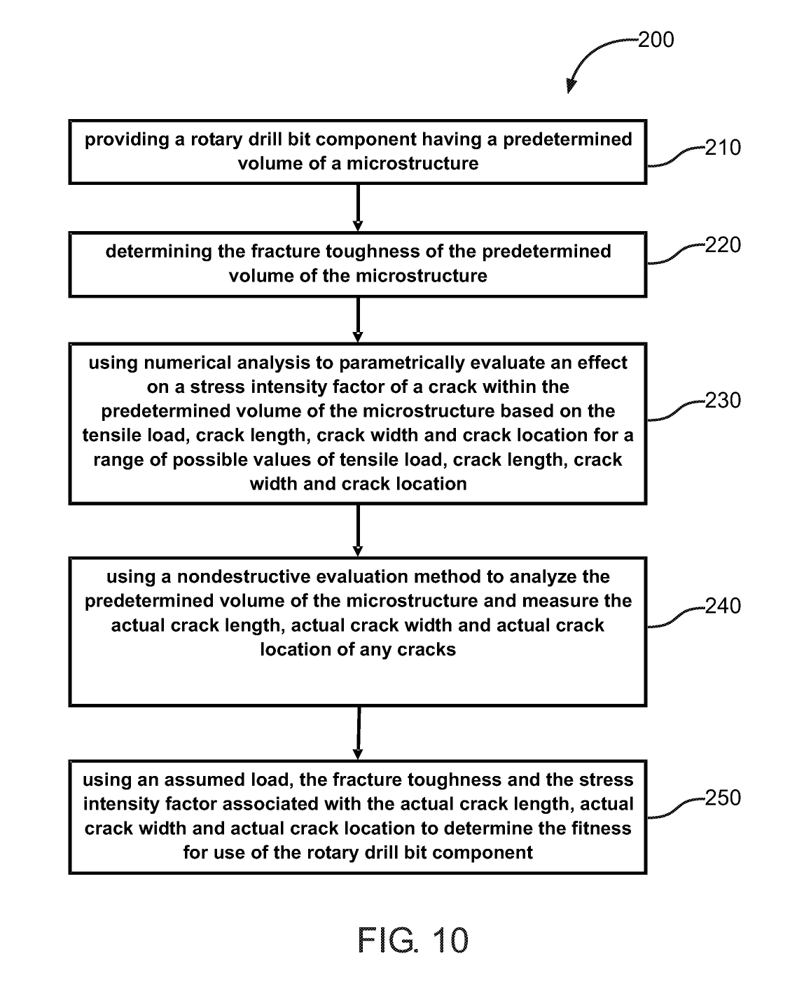

Referring to FIG. 3, method 100 also includes providing 120 an ultrasonic test system 60 comprising a phased array (e.g., 64 element, 0.6 mm pitch, 5 Mhz operating frequency) ultrasonic transducer 62, an ultrasonic signal generator 64, a signal processor 66 and a storage device 68 or plurality of devices, as shown in FIG. 4. An example of a suitable test system is a Tomoscan Focus LT phased-array ultrasonic tester manufactured by Olympus NDT. The system may also be coupled with a suitable output device 69, including a computer display 70 or a printer 72 configured to display a human viewable image. As used herein, phased-array ultrasonic testing (PAUT) describes a non-destructive evaluation (NDE) technique that employs ultrasonic transducer 62 in the form of a probe 63 that includes an array of ultrasonic elements (not shown). Probe 63 is movable and is attached to a manual 2-axis manipulator 65 with position encoders to provide scan (rotation about longitudinal axis 67) and index (axial translation along axis 67) ranges sufficient to move the beam to various locations on the surface of bore 40 sufficient to cover the chamfer region of PDC bits where identification of discontinuities and defects is of interest, preferably the entire circumference of bore 40 and an axial range that encompasses the entire axial width of the chamfer 17 and tang 19. Optionally, probe 63 may also incorporate a motor drive or drives for either or both of rotational movement and translational movement. The position data associated with each ultrasonic “exposure” was needed for post evaluation image reconstruction. It will be understood that translation of the probe 63 along bore requires only relative movement of probe 63 and drill bit 10, hence the drill bit may be positioned on a movable fixture (not shown) that enables translation and rotation of the drill bit 10 with respect to a fixed position probe 63 and the position encoder may be associated with the fixture to provide the required position information. The probe 63 serves to center the transducer axis of rotation within the bit bore, particularly for as-manufactured bits. The bores of post-service bits altered by erosion may present variations in the portion of the acoustic path in water when the transducer is centered using probe 63. An alternative to centering the transducer to fix the length of the acoustic path, is to fix the distance from the transducer to the bore surface by placing the transducer in a fixed spacing arrangement from the bore surface, such as a spaced sliding contact, which also has the effect of fixing the length of the acoustic path. Each element in the array can be pulsed independently of the others. By carefully constructing timing sequences, the emitted elastic wave 71 from each element of the array can be dynamically (electronically) focused and steered. To inspect the chamfer areas of, for example, 7⅞″-8¾″ diameter PDC drill bits, the ultrasonic transducer 62 can be placed in the bore 40 of the bit 10. From the ID, the signal is “steered” (with refraction compensation) to chamfer interface area (FIGS. 2 and 3). When the elastic wave interacts with a discontinuity, a portion of the energy is reflected. The fraction reflected is a function of the impedance mismatch; such that the reflected fraction rises with an increase in the impedance mismatch, e.g., at an interface between the microstructure of the metallurgical bond 13 and the defect or discontinuity. Reflected acoustic wave response data including redundant reflections are processed in signal processor 66 collected and stored in the storage device 68 and can be used to construct virtual 2D and 3D images that are representative of the internal microstructure of the drill bit 10, and more particularly bit body 12, and even more particularly crown 14, using suitable image processing software. A comparative example of such images is shown if FIGS. 7 and 8. FIG. 7 illustrates a portion of a chamfer region that is free of defects. By way of contrast, FIG. 8 illustrates a chamfer region that contains a defect. FIG. 9 includes an unwrapped filtered (−6 db) “c-scan” image produced using method 100. The image represents chamfer area that includes a defect. The scan axis or radial length of the defect (0 to 360°) is on the horizontal axis, and is correlated to a linear length and referred to herein as the length of a defect; the index axis is on the vertical axis and referred to herein as the width of a defect. The discontinuity within the rectangle is 13.1 mm long (scan) by 28 mm wide (index). Specifically, ultrasonic test system 60 is configured to produce images that are representative of the volume of the microstructure of bit body 12 that includes the metallurgical bond 13 between the matrix material of crown 14 and chamfer 17 and tang 19 of metal blank 16. An example of a suitable software program is TomoView™, made by Olympus. The software may be configured to manage the acquisition of PAUT signals combined with the real-time imaging of these signals, as well as offline analysis of previously acquired data files. Providing 120 may also extend to the use of test system 60 with other rotary drill components, as described herein. Referring again to FIG. 3, method 100 also includes acoustically coupling 130 the phased array ultrasonic transducer 62 to a location 74 on a surface 76 of the rotary drill component, such as rotary drill bit 10. The surface 76 may include a bore surface 41 of central bore 40. The location 74 may include any suitable starting location 74, including bore surface 41, and more particularly radially inwardly of chamfer 17 or tang 19. Ultrasonic elastic waves are easily attenuated in air, thus making the coupling in air generally undesirable. Acoustic coupling 130 may be performed by immersing ultrasonic transducer in a suitable acoustic coupling medium 78, such as water that preferably reduces, or even more preferably, minimizes the transmitted and reflected signal losses from the transducer 62. Acoustic coupling 130 may also include placing the elements of the phased array transducer 62 in direct contact with surface 76 (not shown).

Method 100 also includes transmitting 140 a plurality of focused ultrasonic acoustic waves into the surface 41 at the location 74 using the phased array ultrasonic transducer 62 and recording a reflected acoustic wave response to the transmitted acoustic waves corresponding to a portion of the predetermined volume of the microstructure of the component, as described herein, associated with the location 74 on the surface.

Method 100 also includes storing 150 the acoustic wave response of the volume of microstructure associated with the location 74 using the storage device 68; and moving 160 one of the transducer 62 or the component, such as rotary drill bit 10, relative to the other to a plurality of unique locations 74.1, 74.2, 74.3, 74.4 . . . 74.n cover the axial and rotation extent of bore surface 41 of interest, each of the plurality of locations 74.1-74n, corresponds to a respective portion of the predetermined volume of the microstructure.

Method 100 and step 160 further includes repeating the steps of transmitting 140 and recording for the acoustic wave response associated with each of the plurality of locations 74-74n, effectively as a scan of the surface, wherein the sum of the respective portions equals the predetermined volume; and processing 170 the reflected acoustic wave responses associated with the predetermined volume of microstructure and providing an output signal representative of the reflected acoustic wave responses to an output device 69, wherein the output device 69 is configured to provide an output indicative of differences in the output signal within the predetermined volume of the microstructure, such as a human readable image on a computer display.

Determination of defect dimensions from the scan results required calibration of the tester using calibration components 80 as standards of comparable size and material characteristics with defects having a known length, width and location. This may be performed, for example, using two calibration bits, one made entirely of steel and one made from a particle-matrix composite shell and steel core that include a series of radially oriented flat-bottom holes 82 of varying and known diameters at various axial positions on the 30-degree chamfer, as shown in FIGS. 5 and 6. Calibration was accomplished by imaging and measuring the holes 82 using system 60 and method 100. Corrections are incorporated into a distance-amplitude correction table included in the set-up file for system 60. Thus, method 100 may also include a step of substituting 180 a calibration component that is representative of the size, shape and acoustic response characteristics of the a rotary drill component, such as drill bit 10, in place of the component, the calibration component having a plurality of holes, each having a predetermined width, predetermined length and predetermined location on a surface of the calibration component; performing the steps of claim 1 on the calibration component, wherein the plurality of holes are located within the predetermined volume of the microstructure; using the differences in the acoustic wave responses associated with the predetermined locations, as well as the predetermined depth and predetermined width to provide calibration information; and using the calibration information with the output indicative of differences in the output signal within the predetermined volume of the microstructure to correlate the differences in the output signal with actual depth and actual width within the predetermined volume of the microstructure. Non-destructive evaluation of selected as-manufactured drill bits 10 imaged using PAUT indicated a minimum detectable discontinuity in the chamfer region of less than about 5 mm (0.197″). With image registration, discontinuity images were reproducible and accurate to within about 5 mm. Accuracy improvements are possible with distance amplitude corrections (DAC).

The defects and discontinuities, such as cracks, identified and characterized with respect to crack length, width and location or bias using method 100 may be also be used to determine fitness-for use of a drill bit 10 that has been so characterized. The fitness-for-use may include identifying whether a given drill bit 10 is suitable for use in view of a design limit, e.g., maximum axial or torsional load, for a given application. Similarly, establishing fitness-for-use may include grading a drill bit 10 for use (or exclusion from use) in one of several different applications, depending on the load requirements for those applications. For example, the maximum design loads for drilling in various earth strata ranging from less resistant glacial till and sedimentary deposits, having relatively lower loads, to extrusive igneous strata, having relatively higher loads, can be established empirically, or using numerical analysis, or a combination thereof, and a fitness-for-use of a drill bit 10 for the application or strata may be determined using information developed by application of method 100. Establishing fitness-for-use may be used with all manner and use conditions of rotary drill bits 10, or other rotary drill components, including those in the as-manufactured, post-service, post-repair, post-rework or other conditions, including a combination of thereof.

A method 200 of determining fitness-for-use of a rotary drill component includes providing 210 a rotary drill component having a predetermined volume of a microstructure, wherein there is a potential or non-zero probability for the existence of a crack within the predetermined volume. As noted herein, for a rotary drill bit 10, including a particle-matrix composite drill bit 10, a predetermined volume of the microstructure that a potential or non-zero probability for the existence of a crack within the predetermined volume includes the chamfer region proximate the chamfer 17 or tang 19.

The method 200 also includes determining 220 the fracture toughness of the predetermined volume of the microstructure. The load behavior, such as the tensile behavior, to failure of drill bit 10 is needed in conjunction with the implementation of method 200, particularly the load behavior, such as the tensile behavior of metallurgical bond 13 and the blank 16/crown 14 interface. This may be determined empirically by pulling drill bits to failure while measuring the load deflection behavior, such as by fastening poisson strain gages proximate the joint of interest. For example, pre or post-service bits may be tested using a fixture, such as that shown schematically in FIG. 12. Tooling may be developed to facilitate the axial-tensile-loading-to-failure of the bits, such as the configuration shown generally in FIG. 12, where a collar is placed over the shoulder to restrain it and a shank adaptor is threaded onto the shank. Load may be applied to the shank as shown in FIG. 12. Poisson strain gages may be attached to the wrench flats of the bits to be tested. The drill bits to be tested may be screened using method 100 to determine whether cracking exists and its relative severity. The load response specimens, such as tensile, compressive, torsional and mixed mode specimens may be selected, for example, to be representative of the widest range of flaw behavior, from clean bits with no cracking to the most sever cracking, in order to develop the maximum range of load (e.g., tensile, compressive, torsional or mixed) behavior characteristics. In the example described, the unflawed drill bits evidenced ductile fracture. The axial load may be applied to the bit under strain-rate control at a rate of about 2-10 μin/in/sec. In the exemplary bit configurations described, similarly configured drill bits 10 would be expected to fail within a range of about 55 to about 847 klbf.

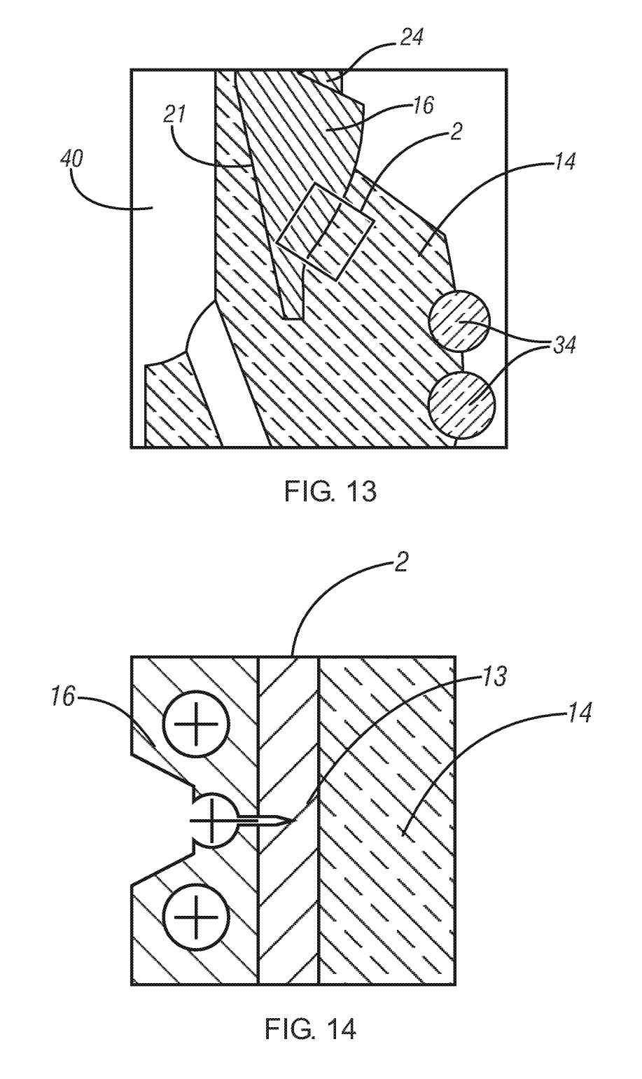

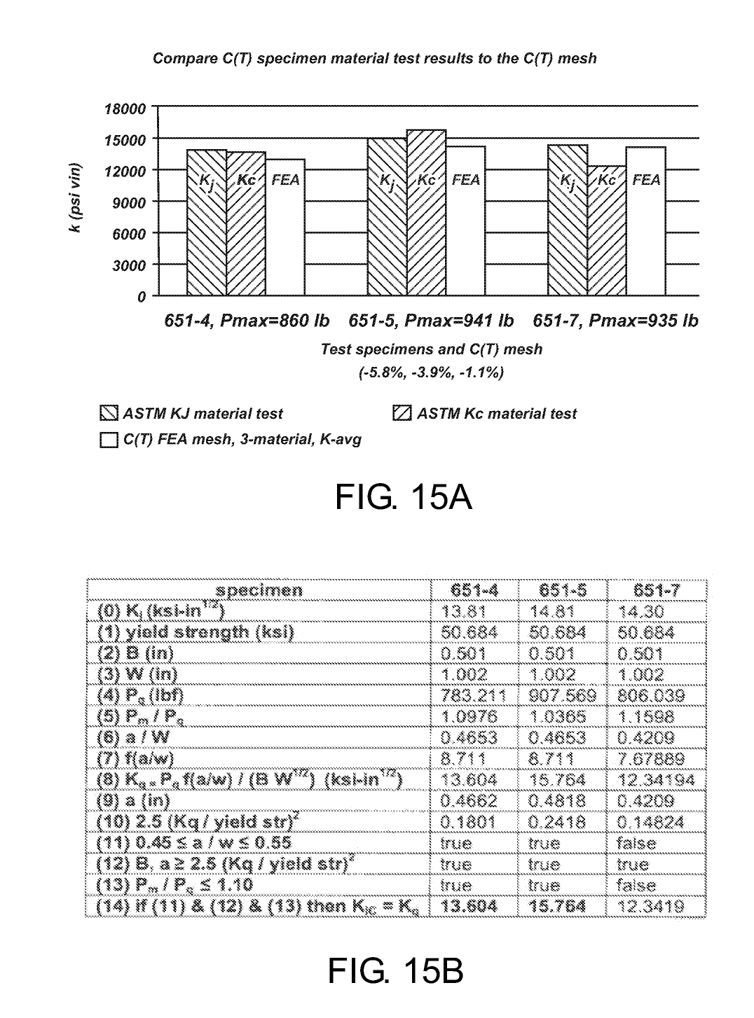

Several three-material (AISI 1018 steel, matrix material, particle-matrix composite material) “½-T” compact-tension specimens were machined from special drill bits featuring square pyramidal chamfer interfaces (a schematic illustration is shown in FIGS. 12 and 13). The specimens were machined so that the approximately 0.20″ thick layer of metallurgical bond 13 (WC/W₂C devoid layer) was centered about the notch. In addition, several 4-inch cubic specimens (2″×4″×4″ steel coupon bonded to a 2″×4″×4″ metal-matrix composite coupon) were prepared using standard infiltration methods. Additional three-material “½-T” compact tension specimens were machined from the cubic specimens. Each specimen was fracture-toughness tested in accordance with ASTM E 1820-01. The results were checked against the validity constraints listed in the ASTM specification. Since E 1820-01 presumes a single material, three-material compact-tension were modeled and analyzed using the finite element method (FEACrack and Abaqus). Analytically-derived load deflection curves were compared with empirically-derived curves. The empirically-derived load-deflection curves collected during fracture toughness testing were similar to the FEA-derived curves. Stress intensity factors, both calculated and measured were compared. The FEA-derived (from U and normal stress) K values were also similar to the empirical ASTM K values (FIG. 15A). It is preferred that the three-material CT models be used to verify the ASTM E 1820-01-derived results which assume a single material. Agreement was judged to be acceptable so the results were used in preparing the failure analysis diagrams described herein. For this work, K was estimated from the FEA CT model (at 1000 lbf) and scaled for each of the Pmax loads reported. In preparing the failure analysis diagrams an approximate average value, K_{IC}=14 ksi-in^{1/2}, was assumed. A summary of the fracture toughness measurements is provided in FIG. 15B.

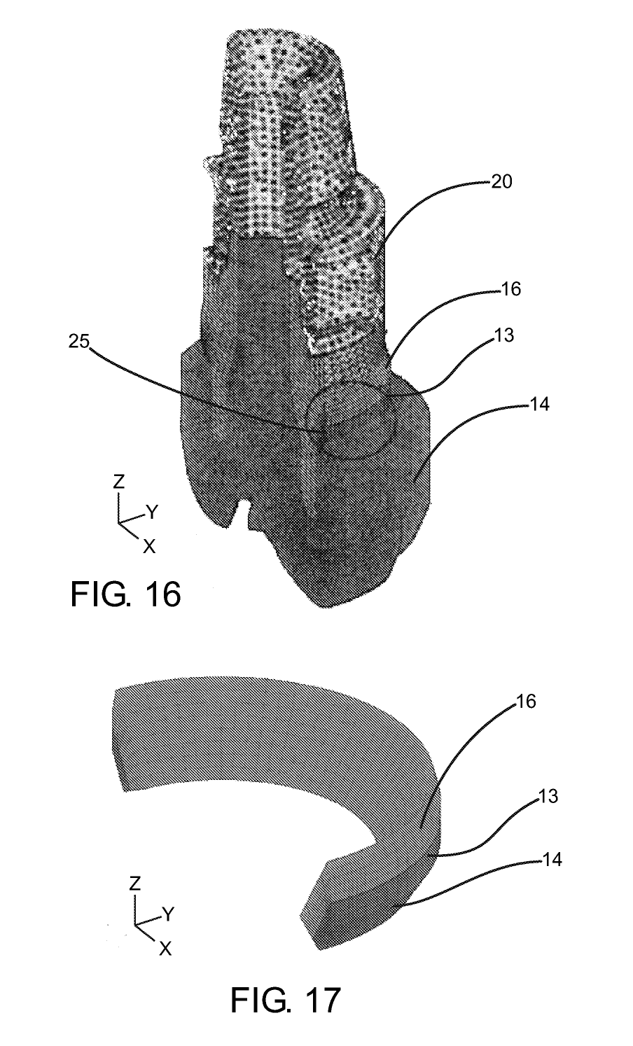

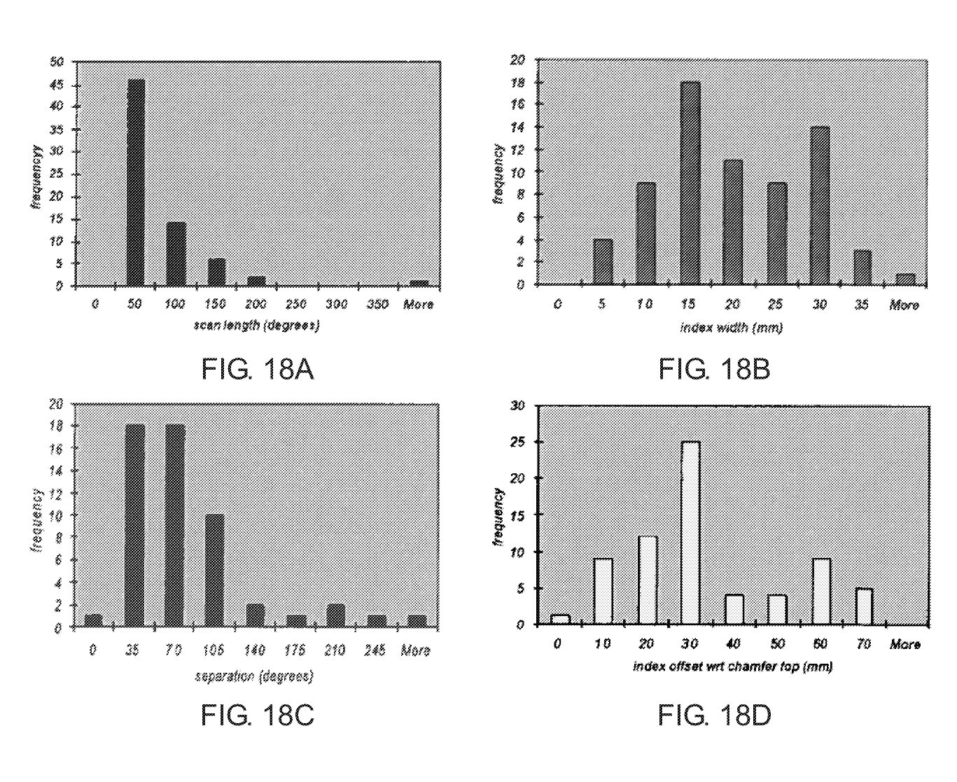

The method 200 also includes using 230 finite element analysis to parametrically evaluate an effect on a stress intensity factor of a crack within the predetermined volume of the microstructure based on the load (e.g., tensile load, compressive, torsional or mixed), crack length, crack width and crack location for a range of possible values of load (e.g., tensile load, compressive, torsional or mixed), crack length, crack width and crack location. The parametric evaluation may test the effect of the embedded crack dimensions, including the scan length (2c), index width (2a) and bias (d), or radial distance of the defect from the chamfer 17 or tang 19 for a load range of about 20 klbf to about 960 klbf. A standard production drill bit 10 may be utilized to develop the model for the evaluation of the embedded crack analysis. In the example shown in FIGS. 16 and 17. The conic section that includes the chamfer/matrix/particle composite material was created as a subordinate mesh and merged with one representing the remainder of the bit to form the model that was used in the analysis. The model may be a half-symmetric model consisting of the bit model and the “tied” conic section. Multiple material, such as, for example, five distinct material groups may be represented, for example, an AISI 4145 steel shank, a plain-carbon steel (weld), an AISI 1018 steel blank, a copper-nickel braze at the metallurgical bond 13 and particle-matrix composite bit. In the model, boundary conditions may be applied to the shank and to the symmetry plane; various distributed axial loads are applied to the cone of the bit. Similarly, the tied conic section may include multiple material groups, such as, for example, three material groups, including; AISI 1018 steel blank 16 in the upper section, metal-matrix composite crown 14 in the lower section 14 and the 0.020″ thick joint region including metallurgical bond 13. In the composite model, the inner, lower and outer surfaces are “tied”, respectively, to corresponding surfaces on the steel bit blank and on the particle-matrix material of the crown. The propagated crack-front mesh for a semi-circular embedded crack 25 is visible in the lower OD surface of the particle-matrix material of crown 14. Discontinuity attribute distributions are shown in FIGS. 18A-D, including length (degrees) about the scan (circumferential) axis (FIG. 18A), width (mm) along the index (parallel to bit axis) direction, separation (degrees) about the scan (circumferential) axis and offset (mm) along the index (parallel to the bit centerline) axis.

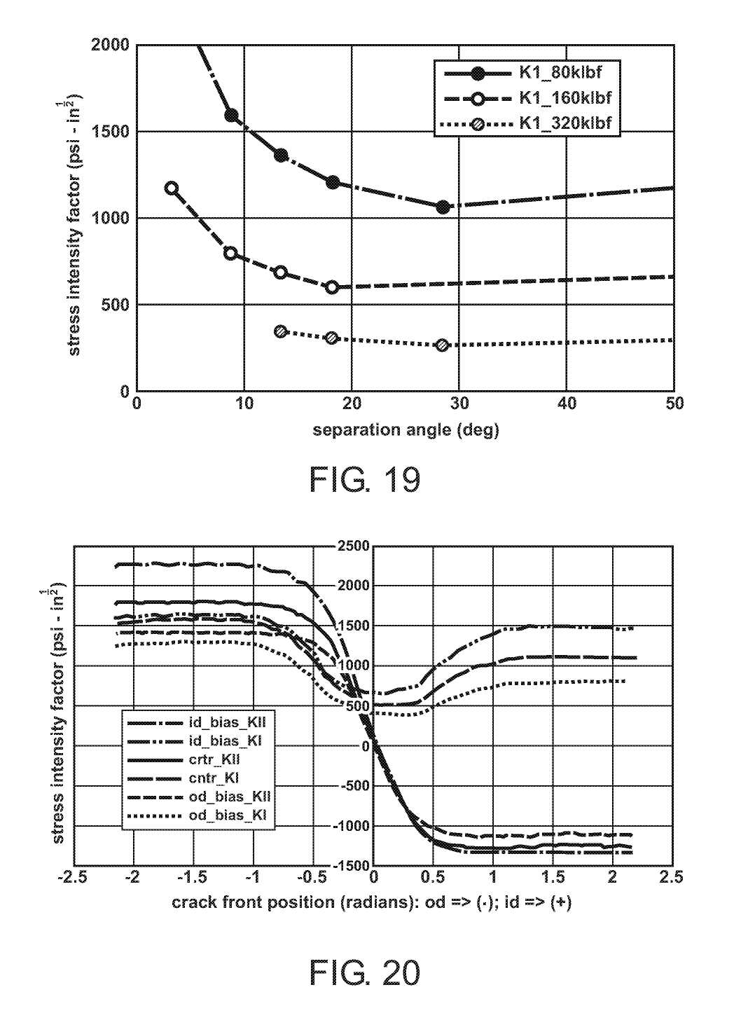

Referring to FIG. 19, mode I and II stress-intensity factors are shown as a function of discontinuity separation. Analyses are based upon centered constant-depth (versus elliptical) discontinuities, for 80, 160- and 320 klbf tensile loads. Discontinuities separated by less than 30 degrees can be treated as a single discontinuity.

Referring to FIG. 20, mode I and II stress-intensity factors versus constant-depth crack-front position (−π/2 near bit OD; +π/2 near bit ID) for 160-klbf-tensile load. Plot suggests that stress intensity factors corresponding to crack-front positions nearest the bit OD are greater than those nearest the bit ID. Offsetting the crack (perpendicular to the major axis of the crack by about 0.130″) along the chamfer towards the bit OD results in increased stress-intensity factors; conversely, offsetting the crack towards the bit ID by a similar amount reduces the stress-intensity factors.

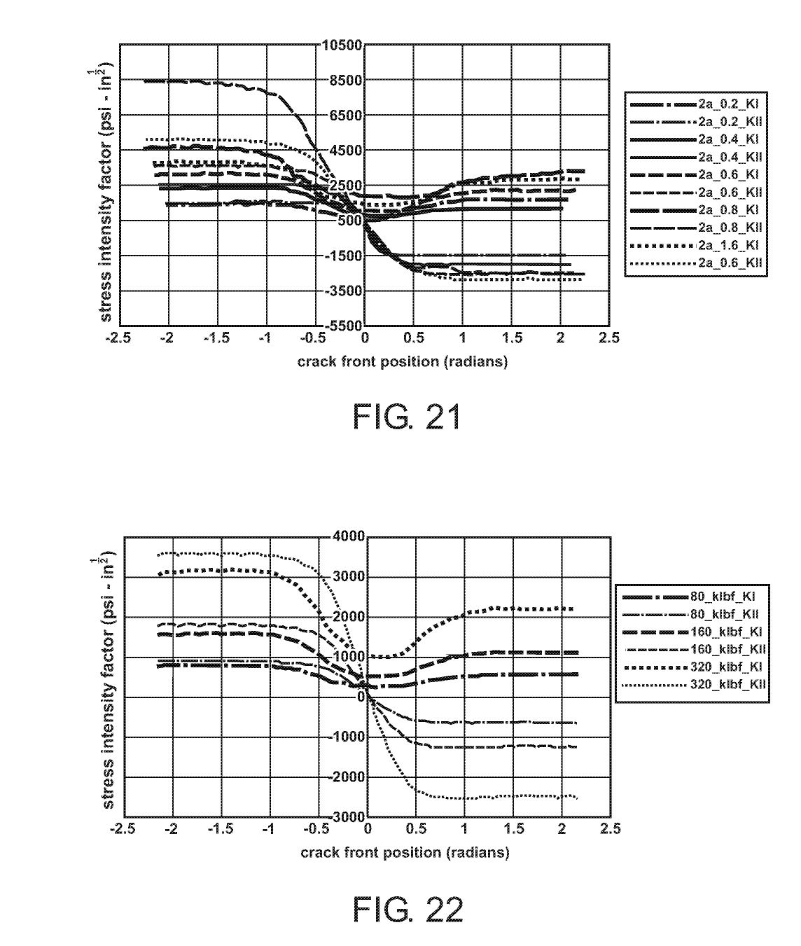

Referring to FIG. 21, mode I and II stress-intensity factors versus constant-depth crack-front position (−π/2 near bit OD; +π/2 near bit ID) for five crack widths, the narrowest, 0.2 in, represents 55.6% of the chamfer width and the second which is approximately 1 in wide represents 92.3% of the chamfer width; both were subjected to a simulated 320-klbf-tensile load. The plot suggests that stress intensity factor corresponding to bit OD is greater than that for bit ID. The plot also suggests that increasing width results in an increase in stress intensity factor all along the crack front, i.e., the factors are sensitive to crack proximity to the OD.

Referring to FIG. 22, mode I and II stress-intensity factors versus constant-depth-crack-front position (−π/2 near bit OD; +π/2 near bit ID) for centered 83.3-degree-long cracks under various loads (80, 160 and 320 klbf tensile loads). Plot suggests that stress-intensity-factor corresponding to bit OD is greater than that for bit ID. The plot also suggests that increasing the tensile load results in an increase in stress-intensity-factor along the crack front.

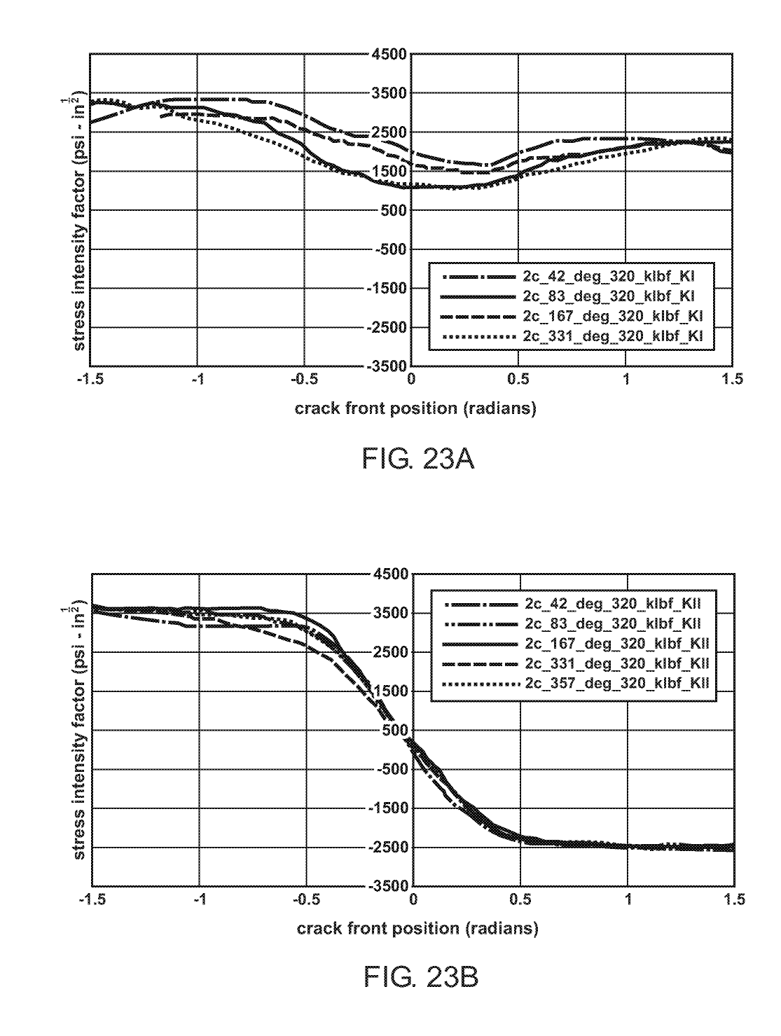

Referring to FIGS. 23A and 23 B, mode I (top) and mode II (bottom) stress-intensity factor versus constant-depth crack-front position (−π/2 near bit OD; +π/2 near bit ID) for various-length-centered cracks (42-degree to 331-degree included angles) under 320-klbf-tensile loads. Plot suggests that stress intensity factor corresponding to bit OD is greater than that for bit ID. The plot also suggests that increasing the crack length results in a minor change stress-intensity factors along much of the crack front.

Method 200 also includes using 240 a nondestructive evaluation method to analyze the predetermined volume of the microstructure of the as-manufactured rotary drill bit component to determine whether a crack exists within the predetermined volume, and if no crack exists, determining that the component is fit for use up to a predetermined maximum design load, and if a crack exists; measuring the actual crack length, actual crack width and actual crack location; and using an assumed load, the fracture toughness and the stress intensity factor associated with the actual crack length, actual crack width and actual crack location to determine the fitness-for-use of the rotary drill bit. This step may be performed as previously described herein using method 100.

The method 200 also includes using 250 an assumed load, the fracture toughness and the stress intensity factor associated with the actual crack length, actual crack width and actual crack location to determine the fitness-for-use of the rotary drill component.

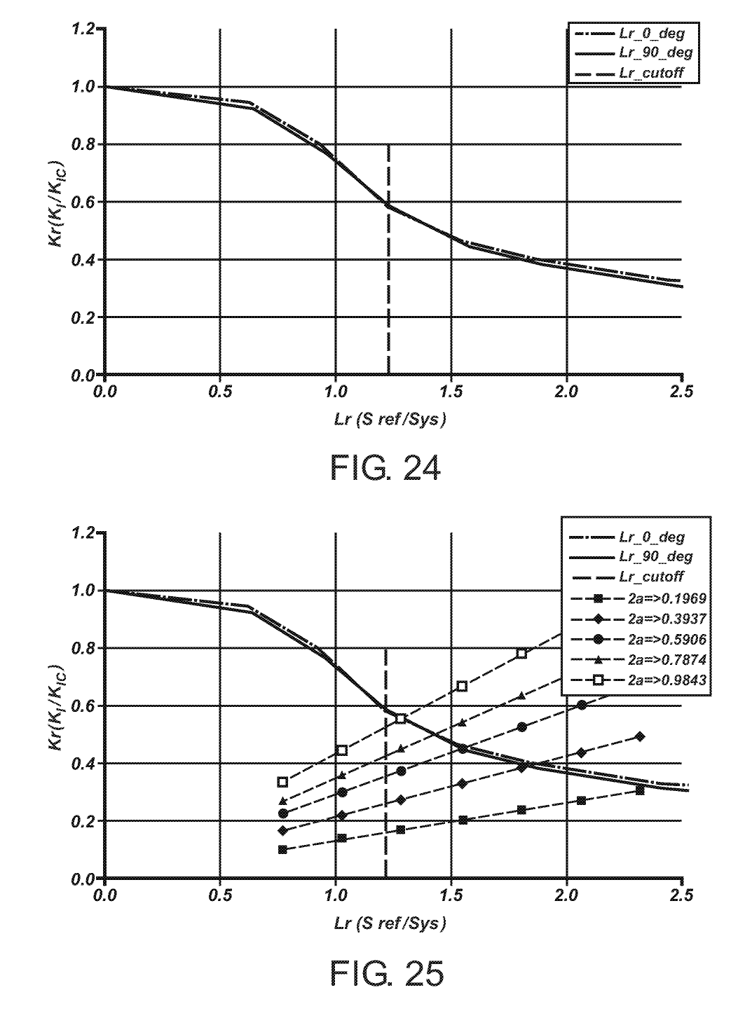

Referring to FIG. 24, a Failure Analysis Diagram (FAD) for a 7⅞″ diameter drill bit is provided. Lr-cutoff is 1.22 and is the ratio of the binder flow strength to the yield strength, or a reference stress to either the yield stress or the plastic flow stress—this is commonly referred to as the load ratio. The “safe” or fit-for-use region is constrained by Lr cutoff (less than) and the Lr_{—}90_degree curve (less than).

Referring to FIG. 25, the FAD of the drill bit of FIG. 24 is shown. The effect of discontinuity width and load are indicated by the scatter plot overlays. For each individual plot, the points (left to right) represent loads of 340, 427, 533, 640, 747, 853 and 960 klbf, respectively. Generally, 340 and 427 klbf are in the “safe” or fit-for-use region. If a measurement uncertainty of 4 mm is assumed, then discontinuity widths less than 0.7874 and loads less than 427 klbf are in the “safe” or fit-for-use region.

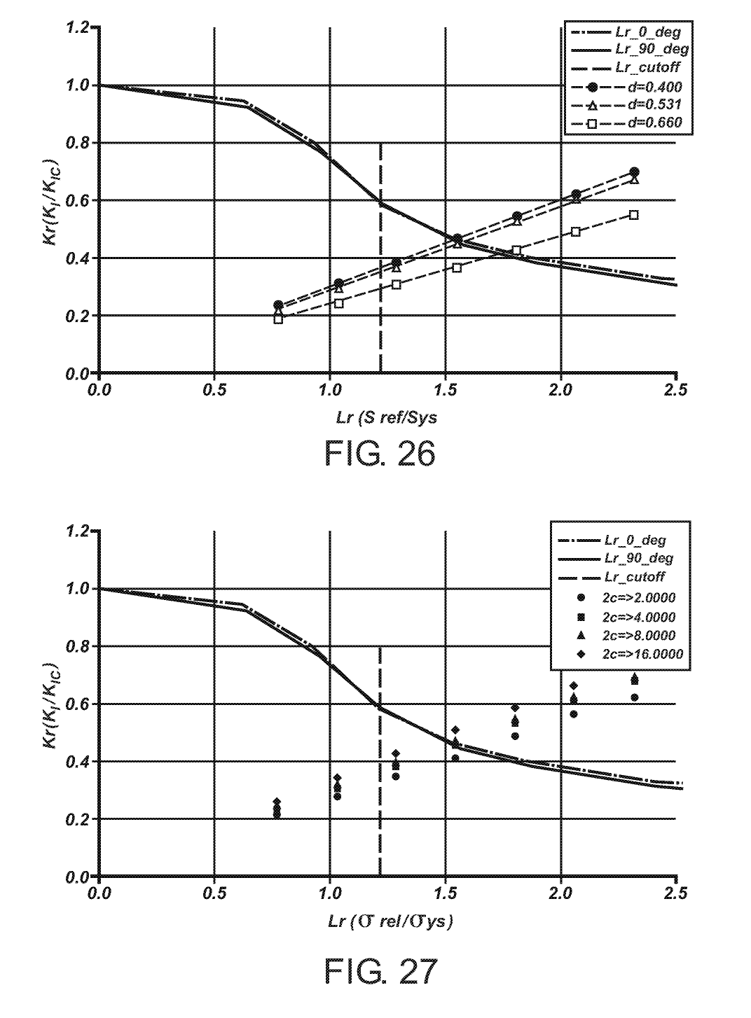

Referring to FIG. 26, the FAD of the drill bit of FIG. 24 is again shown. The effect of discontinuity bias (the position difference between the chamfer and the discontinuity centers) is indicated by the scatter plot overlays. For each individual plot, the points (left to right) represent loads of 340, 427, 533, 640, 747, 853 and 960 klbf, respectively. When d=0.660″, the discontinuity center is shifted from the chamfer center toward the tang by 0.129″ and the Kr values are reduced. The opposite is true when the discontinuity center is shifted toward the bit OD. Generally, 340 and 427 klbf are in the “safe” or fit-for-use” region for all bias values tested.

Referring to FIG. 27, the FAD of the drill bit of FIG. 24 is again shown. The effect of discontinuity length is indicated by the scatter plot overlays. For each individual plot, the points (left to right) represent loads of 340, 427, 533, 640, 747, 853 and 960 klbf, respectively. Generally, 340 and 427 klbf are in the “safe” or fit-for-use region for all lengths tested.

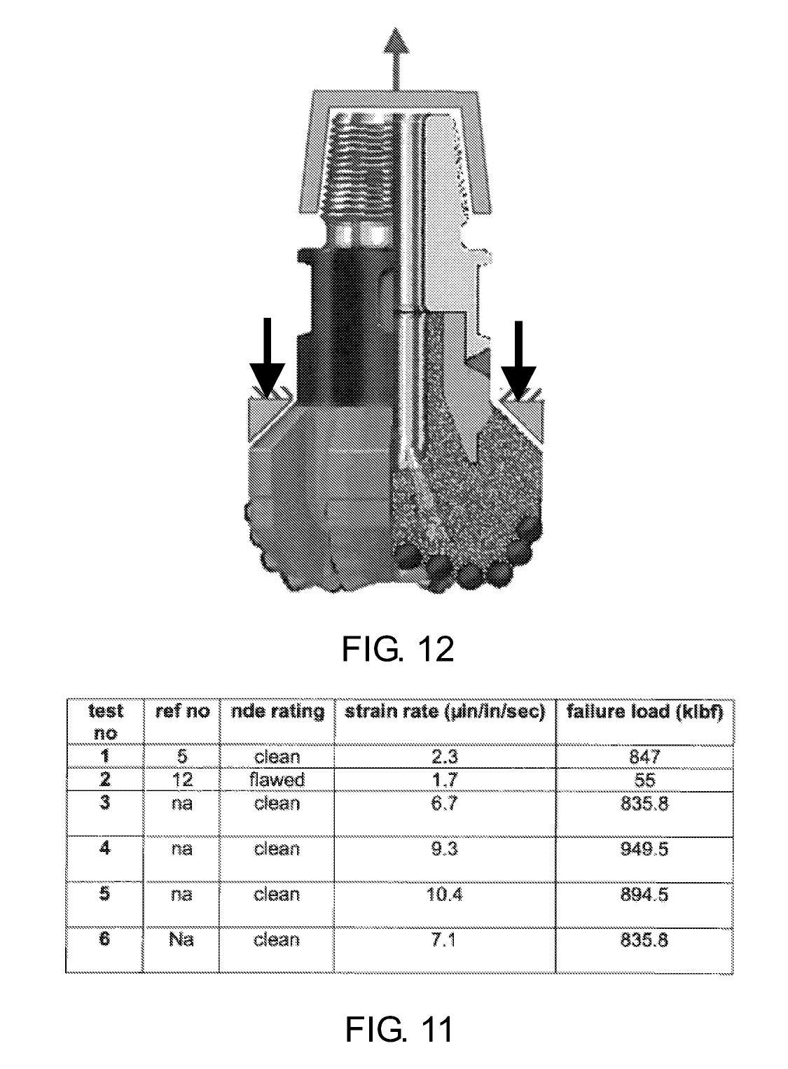

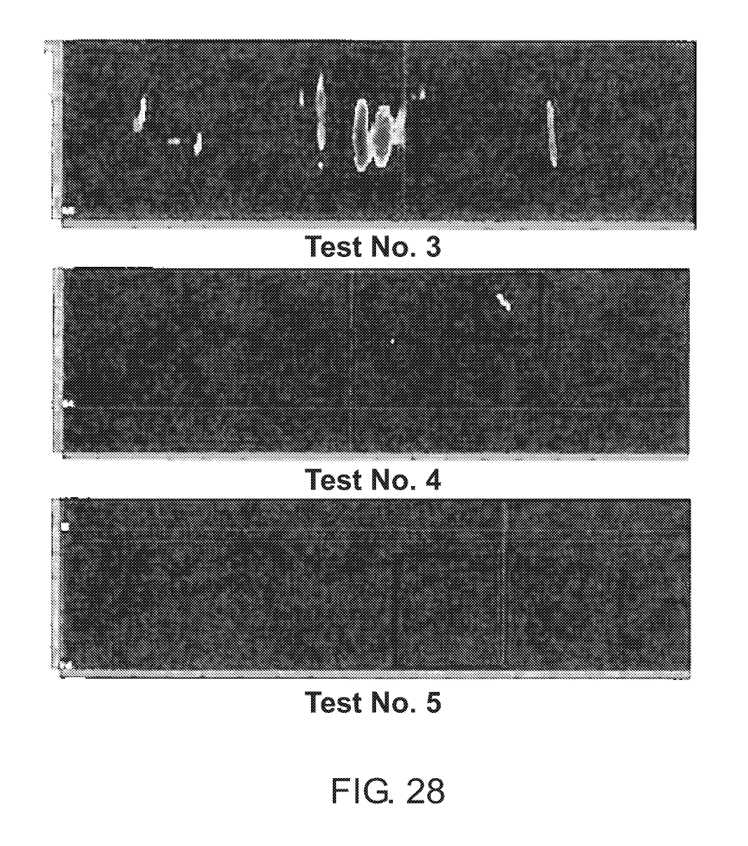

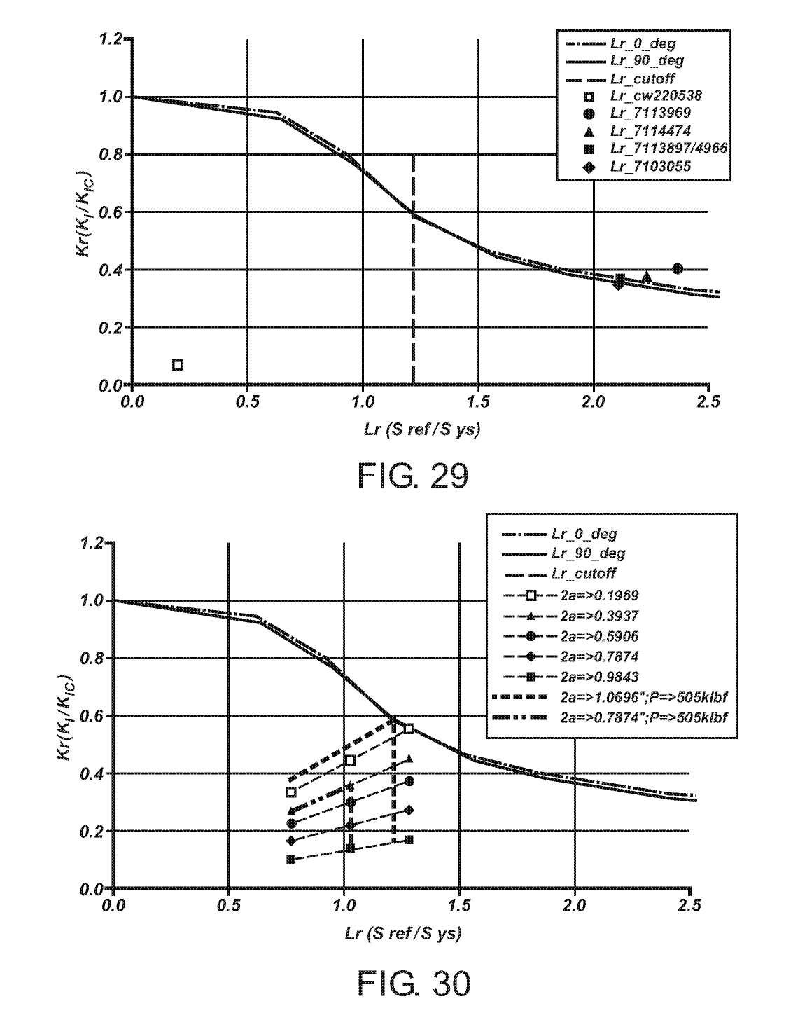

Verification of the FAD has been demonstrated by recovering drill bits from service. Each bit was imaged using PAUT. The images (C-scan—unwrapped chamfer projections) were reviewed and the discontinuities were measured (see FIG. 28). The “C-scan” images for Test Nos. 3, 4 and 5 are shown, respectively, top to bottom. The dark areas in the top and bottom image were measured and used in the calculation of Kr, Lr points for the FAD. Each bit was tensile tested as described herein and the failure load was recorded (see FIG. 11). Based upon the discontinuity dimensions, stress intensity factors and reference stress were estimated from the analytical models. Finally, the maximum stress intensity factor and reference stress were scaled by the plain strain stress intensity factor and yield strength, respectively, and plotted on the FAD (see FIG. 29). The test results confirmed the PAUT imaging. The PAUT images showed very clean bits, i.e., relatively few defects. The results plotted in FIG. 29 show that four bits of the same configuration as represented by the FAD failed outside the predicted “safe” zone (i.e., to the right of the predicted plastic collapse load ratio); a fifth bit which is not represented by the FAD is shown within the safe zone.

In conjunction with preparation of the Failure Analysis Diagrams and estimating stress intensity parameters from analytical models, the following observations were noted. As the separation between adjacent circumferential discontinuities approaches 30 degrees (from above) for loads of 320 klbf and less, the stress intensity factors (K_{I}) for each is affected by proximity of the other (see FIG. 19). For an embedded discontinuity centered on a fixed chamfer width, the stress intensity factor (K_{I}) associated with the portion of the discontinuity front closest to the bit OD (crack front angle)<0° are greater than those associated with positions closest to the ID (see FIG. 20). The differences are due to differences in constraint between ID (tang, etc.) and OD. For embedded discontinuities centered on a fixed chamfer width, the stress intensity factor (K_{I}) increases with increasing discontinuity width. Stress intensity factors associated with portions of the front closest to the OD are greater than those associated with positions closest to the ID (see FIG. 21). For embedded discontinuities centered on a fixed chamfer width, the stress intensity factor (K_{I}) increases with increasing discontinuity length (for a range of included angles of 42 to 331 degrees). The factors were less sensitive to length changes than they were to changes in width. As noted previously, factors associated with positions closest to the OD were greater than the symmetric counterparts nearest the ID (see FIGS. 23A and 23B). For embedded discontinuities centered on a fixed chamfer width, the stress intensity factor (K_{I}) increases linearly with increasing load (see FIG. 22). As noted previously, factors associated with positions closest to the OD were greater than the symmetric counterparts nearest the ID. A failure analysis diagram (FAD) was prepared for a 7⅞″ drill bit design. The “safe” of fit-for-use region is the portion of the plot below and to the left of the locus of {Kr,Lr} points forming the Kr-Lr line and the Lr-cutoff (the ratio of plastic flow strength (the asymptotic portion of the stress-strain diagram) to yield strength for the binder). The “unsafe” or not-fit-for-use portion is above and to the right of the region bound by the Kr-Lr line (for values less than Lr-cutoff) and for all values greater than the Lr-cutoff (see FIG. 24). The effect of load (340 klbf-960 klbf), discontinuity width (0.1969″-0.9843″) and discontinuity length (2.00″-16.00″) is illustrated in FIGS. 25-27. FIG. 30 is an FAD for a 7⅞″ drill bit with overlays of limit and reference lines. The reference lines represent the locus of {Kr,Lr} points for a discontinuity of 2a=1.0686″ and for tensile loads of 340 to 505 klbf. The region above and to the right of the reference lines are considered to be “unsafe”. The limit line represents the locus of {Kr,Lr} points for a discontinuity of 2a=0.7874″ and for tensile loads of 340 to 427 klbf. The region below and to the left of the limit lines are considered to be “safe”. In brief, discontinuities less than 4 in aggregate length (clustered if separation is less than 30 degrees), less than 0.7874 in width, further from the bit OD than 5/32″ and for bit tensile loads less than 427 klbf would be considered “safe” (with margins: 0.2812″ in width and 78 klbf in load).

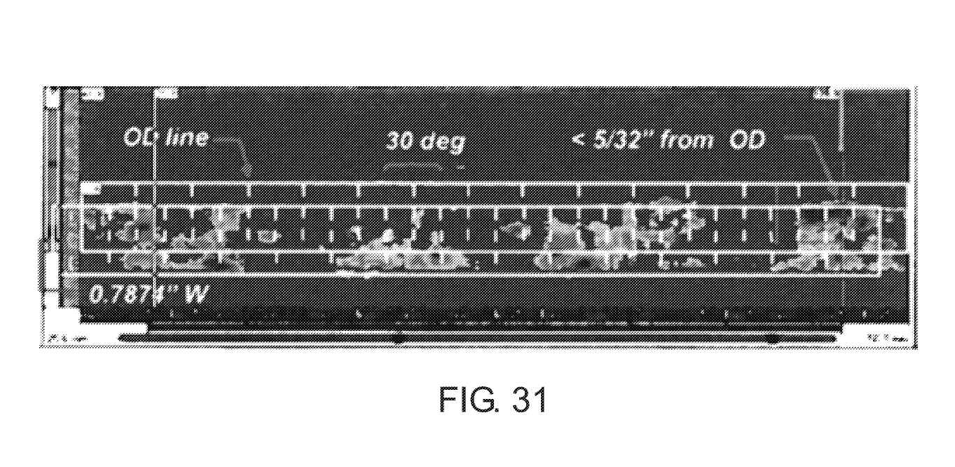

A method for imposing fitness-for-use criteria during inspection involves filtering the c-scan image (−6 dB) and overlaying a template representative of the “safe” limits on a visual display output, either on an electronic output display device (see FIG. 31), such as a computer monitor, PDA or similar electronic display device, or on all manner of printed outputs.

The image represents a bit that would be considered “unsafe” or not fit-for-use due to discontinuity (1) proximity to the bit OD (upper right) and (2) aggregate length exceeding 4″ (83.3 degrees). As described herein; however, this bit may be fit-for-use in applications having lesser load limit requirements. Therefore, specifying a reduced-severity application for the bit may be an alternative to repair or rework. While this describes a relatively straightforward method of using image analysis to apply the service fitness-for use limits, it will be understood that the limits may also be applied using numerical analysis of the data, and all manner of output or indication of either a “safe” or “unsafe” condition for a given application for which the service limits have been used to perform the numerical analysis. The output in any suitable form, or a listing that provides more detailed comparison data. For example, various tabular or spreadsheet outputs may be provided to indicate a “safe” or “unsafe” condition. As another example, audible tones, or visual indicators, such as lights may be used to indicate a “safe” or “unsafe” condition.

A method has been developed and demonstrated that describes the non-destructive imaging of the chamfer interface region of a particle-matrix composite PDC bit, the characterization of the imaged discontinuities, the empirical determination of the interface joint fracture toughness, the analytical determination of the stress intensity factors in the region around the discontinuities and the development of a failure analysis diagram (FAD). The FAD is used to determine fitness-for-service of the bit based on the presence or absence of embedded discontinuities and the characteristics, including length, width and location.

While the description herein presents certain preferred embodiments, those of ordinary skill in the art will recognize and appreciate that it is not so limited. Rather, many additions, deletions and modifications to the preferred embodiments may be made without departing from the scope of the invention as hereinafter claimed. In addition, features from one embodiment may be combined with features of another embodiment while still being encompassed within the scope of the invention as contemplated by the inventors. Further, the invention has utility in drill bits and core bits having different and various bit body profiles as well as cutter types, as well as other rotary drill components.

The foregoing invention has been described in accordance with the relevant legal standards, thus the description is exemplary rather than limiting in nature. Variations and modifications to the disclosed embodiments may become apparent to those skilled in the art. Accordingly, the scope of legal protection afforded will be determined in accordance with the following claims.

We claim:

1. A method of identifying and characterizing defects in a rotary drill component, comprising:
acoustically coupling a phased array ultrasonic transducer to a location on a surface of a rotary drill component;
transmitting a plurality of focused ultrasonic acoustic waves into the surface at the location using the transducer and receiving a reflected acoustic wave response corresponding to a portion of a predetermined volume of a microstructure of the component associated with the location on the surface;
moving one of the transducer or the component relative to the other to a plurality of locations on the surface, each of the plurality of locations corresponding to a respective portion of the predetermined volume of the microstructure, repeating the steps of transmitting and receiving the acoustic wave response associated with each of the plurality of locations, wherein the sum of the respective portions defines the predetermined volume; and
processing the reflected acoustic wave responses associated with the predetermined volume of microstructure and providing an output signal representative of the reflected acoustic wave responses to an output device, wherein the output device is configured to provide an output indicative of differences in the output signal within the predetermined volume of the microstructure.

2. The method of claim 1, further comprising:
substituting a calibration component that is representative of the size, shape and acoustic response characteristics of the component in place of the component, the calibration component having a plurality of holes, each having a predetermined width, predetermined length and predetermined location;
performing the steps of claim 1 on the calibration component;
using differences in the acoustic wave responses associated with the holes to provide calibration information; and
using the calibration information to correlate the differences in the output signal with an actual depth and an actual width within the predetermined volume of the microstructure.

3. The method of claim 1, further comprising:
storing the acoustic wave responses of the volume of microstructure associated with the locations using a storage device.

4. The method of claim 1, wherein the output device is a computer display, printer or disk storage unit.

5. The method of claim 1, wherein the component has a longitudinal axis and moving one of the transducer or the component relative to the other comprises at least one of rotation about and translation along the axis.

6. The method of claim 5, wherein moving further comprises inward or outward radial translation from the longitudinal axis.

7. The method of claim 1, wherein the rotary drill component comprises a rotary roller-cone earth boring drill bit, rotary fixed-cutter earth boring drill bit, rotary diamond-impregnated earth boring drill bit, rotary natural diamond earth boring bit, rotary coring bit, rotary bit bearing for a rotary earth boring drill bit, or a drilling sub.

8. The method of claim 1, wherein the rotary drill component is a rotary fixed-cutter earth boring drill bit comprising:
a bit body configured to carry one or more cutters for engaging a subterranean earth formation, the bit body comprising a particle-matrix composite material having a plurality of hard particles dispersed throughout a matrix material; and
a metal blank having a bit chamfer portion that is joined by a metallurgical bond comprising the matrix to the bit body and a shank portion configured for attachment to a shank.

9. The method of claim 8, wherein the predetermined volume of the microstructure comprises the metallurgical bond.

10. The method of claim 8, wherein the rotary drill component comprises a central bore having a bore surface, and wherein the surface to which the phased array ultrasonic transducer is acoustically coupled comprises the bore surface.

11. The method of claim 10, wherein acoustically coupling comprises placing the phased array ultrasonic transducer in spaced sliding contact with the bore surface.

12. The method of claim 10, wherein acoustically coupling comprises spacing the phased array ultrasonic transducer away from the bore surface and immersing the transducer and the bore surface in an acoustic coupling medium.

13. The method of claim 12, wherein the coupling medium comprises water.

14. A method of determining fitness-for-use of a rotary drill component, comprising:
determining a fracture toughness of a predetermined volume of a microstructure of a rotary drill component;
using numerical analysis to parametrically evaluate an effect on a stress intensity factor of a crack within the predetermined volume of the microstructure based on the load, crack length, crack width and crack location for a range of possible values of load, crack length, crack width and crack location;
using a nondestructive evaluation method to analyze the predetermined volume of the microstructure to determine whether a crack exists therein, and if no crack exists, determining that the component is fit for use up to a predetermined maximum design load, and if a crack exists therein;
determining the actual crack length, actual crack width and actual crack location; and
using an assumed load, the fracture toughness and the stress intensity factor associated with the actual crack length, actual crack width and actual crack location to determine the fitness-for-use of the rotary drill component.

15. A method of claim 14, wherein the rotary drill component comprises an as-manufactured, post-service or post-rework rotary drill component.

16. The method of claim 14, wherein determining the fracture toughness of the predetermined volume of the microstructure comprises empirical determination of the fracture toughness using fracture toughness measurements of a representative test specimen or numerical analysis of the fracture toughness using material property information representative of the predetermined volume of the microstructure, or a combination thereof.

17. The method of claim 14, wherein the numerical analysis comprises finite element analysis using material property information for at least one material that is representative of the predetermined volume of the microstructure.

18. The method of claim 14, wherein using the nondestructive evaluation method comprises using a phased array ultrasonic test system to measure the actual crack length, actual crack width and actual crack location.

19. The method of claim 14, further comprising using the parametric evaluation to define a failure analysis diagram comprising a ratio of a reference stress to a yield stress or a plastic flow stress, as a function of the ratio of the stress intensity factor to the fracture toughness, wherein the failure analysis diagram is used to determine fitness-for-use of the rotary drill component.

20. The method of claim 14, wherein fitness-for-use is determined using a display representative of the actual crack length, actual crack width, and actual crack location superimposed with a display of a predetermined limit for crack length, crack width and crack location, wherein comparison of one of the actual crack length, actual crack width or actual crack location with a corresponding predetermined limit for crack length, crack width or crack location is used to determine fitness-for-use of the rotary drill component.

21. The method of claim 14, wherein determining the fitness-for-use comprises selecting an application environment based on a maximum value for the assumed load associated with that environment as a function of the fracture toughness, stress intensity factor, actual crack length, actual crack width and actual crack location of a crack within the predetermined volume of the microstructure.
